(19) United States
(12) Patent Application Publication
(10) Pub. No.: US 2019/0126248 A1
(43) Pub. Date: May 2, 2019

(54) EXHAUST GAS PURIFYING CATALYST

(71) Applicant: TOYOTA JIDOSHA KABUSHIKI KAISHA, Toyota-shi (JP)

(72) Inventors: Isao CHINZEI, Toyota-shi (JP); Hiromasa SUZUKI, Toyota-shi (JP)

(73) Assignee: TOYOTA JIDOSHA KABUSHIKI KAISHA, Toyota-shi (JP)

(21) Appl. No.: 16/172,951

(22) Filed: Oct. 29, 2018

(30) Foreign Application Priority Data
Nov. 1, 2017 (JP) 2017-211972

(51) Int. Cl. B01J 23/46; B01D 53/94; B01J 23/42; B01J 23/44; B01J 37/02; B01J 23/00

(52) U.S. Cl. CPC B01J 23/464; B01D 2258/01; B01J 23/42; B01J 23/44; B01J 37/0244; B01J 23/002; B01D 2255/9022; B01D 2255/908; B01D 2255/1021; B01D 2255/1023; B01D 2255/1025; B01D 2255/207; B01D 2255/407; B01D 2257/404; B01D 2257/502; B01D 2257/70; B01D 53/945

(57) ABSTRACT

The present disclosure provides an exhaust gas purifying catalyst, in which exhaust gas purifying performance, OSC performance, and pressure loss are optimized, and which has a substrate and two or more catalyst coating layers formed on the substrate, wherein the uppermost catalyst coating layer comprises an OSC material having a pyrochlore-type structure, an OSC material having a faster oxygen storage-release rate than that of the OSC material having a pyrochlore-type structure, and a precious metal catalyst containing at least Rh, wherein, in the uppermost catalyst coating layer, the content of the OSC material having a pyrochlore-type structure is 30 g/L to 50 g/L, based on the volume of the substrate, and the content of the OSC material having a faster oxygen storage-release rate than that of the OSC material having a pyrochlore-type structure is 36 g/L to 72 g/L, based on the volume of the substrate.

### CROSS REFERENCE TO RELATED APPLICATIONS

The present application claims priority from Japanese patent application JP 2017-211972 filed on Nov. 1, 2017, the content of which is hereby incorporated by reference into this application.

### BACKGROUND

### Technical Field

The present disclosure relates to an exhaust gas purifying catalyst.

### Background Art

Exhaust gas discharged from the internal combustion engine of automobiles and the like comprises harmful components such as carbon monoxide (CO), hydrocarbon (HC), and nitrogen oxide (NOx), and these harmful components are released into the atmosphere after they have been purified by exhaust gas purifying catalysts. As such an exhaust gas purifying catalyst, a three way catalyst, which simultaneously performs oxidation of CO and HC and reduction of NOx, has been used. As such a three way catalyst, a porous oxide carrier, such as alumina (Al₂O₃), silica (SiO₂), zirconia (ZrO₂), or titania (TiO₂), on which a precious metal such as platinum (Pt), palladium (Pd), or rhodium (Rh) is supported, has been widely used.

In order to efficiently purify the above-described harmful components existing in exhaust gas, using such a three way catalyst, the air-fuel ratio (A/F) that is the ratio between air and fuel in mixed air supplied to the internal combustion engine must be close to the theoretical air-fuel ratio (stoichiometric ratio). However, depending on driving conditions of automobiles, etc., the actual air-fuel ratio becomes rich (excessive fuel: A/F<14.7) or lean (excessive air: A/F>14.7), having the stoichiometric ratio as a center. Corresponding to such movement, exhaust gas also becomes rich or lean.

In recent years, in order to enhance the exhaust gas purifying performance of a three way catalyst with respect to a fluctuation in the oxygen concentration in exhaust gas, an OSC material that is an inorganic material having oxygen storage capacity (OSC) has been used to a catalyst layer of the exhaust gas purifying catalyst. When the above-described mixed air is lean and the oxygen concentration in exhaust gas is high (lean exhaust gas), the OSC material stores oxygen to facilitate the reduction of NOx in the exhaust gas. On the other hand, when the mixed air is rich and the oxygen concentration in exhaust gas is low, the OSC material releases oxygen to facilitate the oxidation of CO and HC in the exhaust gas.

As such an OSC material, a ceria-zirconia composite oxide has been widely used. In addition, it has been known that OSC performance and exhaust gas purifying performance can be controlled by using, as OSC materials, an OSC material having a pyrochlore-type structure, which has a slow oxygen storage-release rate in comparison to OSC materials having other crystal structures, in combination with an OSC material having a fast oxygen storage-release rate in comparison to the OSC material having a pyrochlore-type structure. When these two types of OSC materials are used as OSC materials, the position of the OSC material added into a catalyst varies depending on desired physical properties or the mode of use.

Regarding the case of using such OSC materials, JP 2015-93267 A, JP 2013-130146 A, JP 2012-24701 A, and JP 2012-86199 A disclose an exhaust gas purifying catalyst, in which an OSC material having a pyrochlore-type structure and an OSC material having a faster oxygen storage-release rate than the OSC material having a pyrochlore-type structure are added into a predetermined position of a catalyst coating layer thereof.

Herein, the exhaust gas purifying catalyst is required to have high exhaust gas purifying performance, high OSC performance, and low pressure loss, and is required to maintain these performances at high levels after endurance activities. However, for example, when a ceria-zirconia composite oxide is used as an OSC material, cerium comprised in the composite oxide reduces exhaust gas purifying performance, although it exhibits OSC performance. As such, if the amount of the OSC material is increased to enhance OSC performance, exhaust gas purifying performance may be decreased in some cases. In addition, if the amount of the OSC material is increased to enhance OSC performance, pressure loss is deteriorated. Thus, in an exhaust gas purifying catalyst comprising an OSC material, OSC performance and exhaust gas purifying performance are contradictory matters, and further, OSC performance and pressure loss are also contradictory matters. Hence, it has been difficult to improve OSC performance without deterioration of exhaust gas purifying performance and pressure loss.

The exhaust gas purifying catalysts disclosed in JP 2015-93267 A, JP 2013-130146 A. JP 2012-24701 A, and JP 2012-86199 A have not been studies in terms of pressure loss, and these exhaust gas purifying catalysts have not exhibited all of exhaust gas purifying performance, OSC performance, and pressure loss at high levels.

### SUMMARY

As described above, conventional exhaust gas purifying catalysts, in which an OSC material having a pyrochlore-type structure is used in combination with an OSC material having a faster oxygen storage-release rate than the OSC material having a pyrochlore-type structure, have not been optimized in terms of exhaust gas purifying performance, OSC performance, and pressure loss. Accordingly, the present disclosure provides an exhaust gas purifying catalyst, in which exhaust gas purifying performance, OSC performance, and pressure loss are optimized.

As a result of intensive studies regarding the means for solving the aforementioned problem, the present inventors have found that the exhaust gas purifying performance, OSC performance, and pressure loss of an exhaust gas purifying catalyst can be optimized by using an OSC material having a pyrochlore-type in combination with an OSC material having a faster oxygen storage-release rate than the OSC material having a pyrochlore-type structure, in predetermined contents, in the uppermost catalyst coating layer of the exhaust gas purifying catalyst, thereby completing the present disclosure.

Specifically, the gist of the present disclosure is as follows.

(1) An exhaust gas purifying catalyst having a substrate and two or more catalyst coating layers formed on the substrate, wherein the uppermost catalyst coating layer comprises

an OSC material having a pyrochlore-type structure,

an OSC material having a faster oxygen storage-release rate than that of the OSC material having a pyrochlore-type structure, and

a precious metal catalyst containing at least Rh, wherein

in the uppermost catalyst coating layer, the content of the OSC material having a pyrochlore-type structure is 30 g/L to 50 g/L, based on the volume of the substrate, and the content of the OSC material having a faster oxygen storage-release rate than that of the OSC material having a pyrochlore-type structure is 36 g/L to 72 g/L, based on the volume of the substrate.

(2) The exhaust gas purifying catalyst according to the above (1), wherein the OSC material having a pyrochlore-type structure and the OSC material having a faster oxygen storage-release rate than that of the OSC material having a pyrochlore-type structure are both ceria-zirconia composite oxides.
(3) The exhaust gas purifying catalyst according to the above (1) or (2), wherein the catalyst coating layer has a two-layer structure.
(4) The exhaust gas purifying catalyst according to any one of the above (1) to (3), wherein, in the uppermost catalyst coating layer, the precious metal catalyst containing at least Rh is supported on the OSC material having a faster oxygen storage-release rate than that of the OSC material having a pyrochlore-type structure.
(5) The exhaust gas purifying catalyst according to any one of the above (1) to (4), wherein at least one catalyst coating layer other than the uppermost layer comprises a carrier and a precious metal catalyst containing at least one of Pd or Pt that is supported on the carrier.

According to the present disclosure, it becomes possible to provide an exhaust gas purifying catalyst, in which exhaust gas purifying performance, OSC performance, and pressure loss are optimized.

### BRIEF DESCRIPTION OF THE DRAWINGS

FIG. 1 is a graph showing the relationship between the amount of pyrochlore ZC added and OSC performance, upon addition of a predetermined amount of ACZ;

FIG. 2 is a graph showing the relationship between the amount of ACZ added and the contribution of pyrochlore ZC to the improvement of OSC or pressure loss, upon addition of a predetermined amount of pyrochlore ZC (30 g/L), wherein square indicates pressure loss and diamond indicates the contribution of pyrochlore ZC to the improvement of OSC; and

FIG. 3 is a graph showing the relationship between the amount of pyrochlore ZC added and the NOx purification percentage or OSC performance, upon addition of a predetermined amount of ACZ (72 g/L), wherein square indicates OSC performance and diamond indicates the NOx purification percentage.

### DETAILED DESCRIPTION

Hereinafter, preferred embodiments of the present disclosure will be described in more detail.

The present disclosure relates to an exhaust gas purifying catalyst. The exhaust gas purifying catalyst of the present disclosure has a substrate and two or more catalyst coating layers formed on the substrate.

The substrate is not particularly limited, and any given material that is generally used as an exhaust gas purifying catalyst can be used. Specifically, as a substrate, a honeycomb-shaped material having a large number of cells can be used. Examples of the substrate that can be used herein include: ceramic materials having heat resistance, such as cordierite (2MgO.2Al₂O₃.5SiO₂), alumina, zirconia, or silicon carbide: and metallic materials consisting of metal foils, such as stainless steel. From the viewpoint of costs, among these materials, cordierite is preferable.

The catalyst coating layers are formed on the substrate. Exhaust gas supplied to the exhaust gas purifying catalyst is allowed to come into contact with the catalyst coating layers, while it moves along the flow channel of the substrate, so that harmful components are purified. For example, CO and HC comprised in exhaust gas are oxidized by the catalytic function of the catalyst coating layers, so that they are converted (purified) to water (H₂O), carbon dioxide (CO₂), etc. On the other hand, NOx comprised in exhaust gas is reduced by the catalytic function of the catalyst coating layers, so that it is converted (purified) to nitrogen (N₂).

The entire length of a catalyst coating layer is not particularly limited from the viewpoint of appropriate purification of harmful components comprised in exhaust gas, production costs, and flexibility in the apparatus designing, and it is, for example, 2 cm to 30 cm, preferably 5 cm to 15 cm, and more preferably approximately 10 cm.

The exhaust gas purifying catalyst has two or more catalyst coating layers. The catalyst coating layer consists of preferably two, three or four layers, and more preferably two layers. The catalyst coating layer preferably has a two-layer structure consisting of a lower catalyst coating layer formed on the substrate and an upper catalyst coating layer formed on the lower catalyst coating layer.

In the exhaust gas purifying catalyst, the uppermost catalyst coating layer is established in a range from the end of the exhaust gas purifying catalyst on the downstream side to 60% to 100% of the entire length of the substrate, in some embodiments. Lower catalyst coating layers other than the uppermost layer are established in a range from the end of the exhaust gas purifying catalyst on the upstream side to 60% to 100% of the entire length of the substrate, in some embodiments.

In the exhaust gas purifying catalyst, the uppermost catalyst coating layer comprises an OSC material having a pyrochlore-type structure, an OSC material having a faster oxygen storage-release rate than the OSC material having a pyrochlore-type structure (hereinafter also referred to as an “OSC material having a fast oxygen storage-release rate”), and a precious metal catalyst containing at least Rh. By using the OSC material having a pyrochlore-type structure, which has a low bulk and a small influence on pressure loss, in combination with the OSC material having a faster oxygen storage-release rate than the OSC material having a pyrochlore-type structure, which has high durability, high activity, and a fast oxygen storage-release rate, in the uppermost catalyst coating layer, the contribution of the OSC material having a pyrochlore-type structure to the improvement of OSC is actualized. Moreover, when the above two types of OSC materials are used in combination, in the uppermost catalyst coating layer, the activity of Rh as catalytic metal does not decrease, and thus, good exhaust gas purifying effects can be obtained.

The OSC material is an inorganic material having oxygen storage capacity. The OSC material stores oxygen when lean exhaust gas is supplied, and it releases the stored oxygen when rich exhaust gas is supplied. Examples of the OSC material include cerium oxide (ceria: CeO₂) and composite oxides comprising the ceria (e.g., ceria-zirconia composite oxide (CZ or ZC composite oxide)). Among the above-described OSC materials, a ceria-zirconia composite oxide is used in some embodiments, because it has high oxygen storage capacity and is relatively inexpensive. The mixing ratio (molar ratio) between ceria and zirconia in this ceria-zirconia composite oxide may be CeO₂/ZrO₂=0.65 to 1.5, and may be preferably CeO₂/ZrO₂=0.75 to 1.3. On the other hand, the weight ratio between ceria and zirconia in the ceria-zirconia composite oxide is, for example, 10:1 to 1:10, preferably 5:1 to 1:5, and more preferably 1:2. The OSC material may also be used as a carrier that carries a catalytic metal.

In the present disclosure, the OSC material having a pyrochlore-type structure has a low bulk and a small influence on pressure loss. On the other hand, the OSC material having a pyrochlore-type structure has a slow oxygen storage-release rate, compared to OSC materials having other crystal structures, and its contribution to the improvement of OSC attended with an increase in the amount added is small.

With regard to the OSC material having a pyrochlore-type structure, the pyrochlore-type structure comprises two types of metal elements, A and B, and when B is a transition metal element, the pyrochlore-type structure is represented by A₂B₂O₇. The pyrochlore-type structure is one type of crystal structure consisting of a combination of A³⁺/B⁴⁺ or A²⁺/B⁵⁺, and it is generated, when the ionic radius of A in a crystal structure having such a configuration is relatively small. When a ceria-zirconia composite oxide is used as the above-described OSC material, the OSC material having a pyrochlore-type structure is represented by the chemical formula: Ce₂Zr₂O₇, and Ce and Zr are alternatively and regularly arrayed, while sandwiching oxygen between them. The OSC material having a pyrochlore-type structure has a slow oxygen storage-release rate, compared to OSC materials having other crystal structures (e.g., a fluorite-type structure). Thus, even after the OSC materials having other crystal structures have completed the release of oxygen, the OSC material having a pyrochlore-type structure still can release oxygen. That is to say, the OSC material having a pyrochlore-type structure can exhibit oxygen storage-release ability, even after the peak of oxygen storage and release by the OSC materials having other crystal structures has been passed. It is understood that this is because the crystal structure of the OSC material having a pyrochlore-type structure is complicated and thus, the passage for storing and releasing oxygen is also complicated. More specifically, in the OSC material having a pyrochlore-type structure, the total oxygen release amount from 10 seconds to 120 seconds after initiation of the oxygen release is, for example, 60% to 95%, preferably 70% to 90%, and more preferably 75% to 85%, based on 100% of the total oxygen release amount from immediately after initiation of the oxygen release (0 second) to 120 seconds.

The OSC material having a pyrochlore-type structure can easily reduce its specific surface area, in comparison to the OSC materials having other crystal structures. The low-bulk OSC material having a pyrochlore-type structure is preferable because it has a small influence on pressure loss. The specific surface area of the OSC material having a pyrochlore-type structure, which is measured by a BET method, is, for example, 10 m²/g or less, preferably 0.1 m²/g to 10 m²/g, and more preferably 1 m²/g to 5 m²/g.

In the present disclosure, the OSC material having a faster oxygen storage-release rate than the OSC material having a pyrochlore-type structure has high durability, high activity, and a fast oxygen storage-release rate.

A specific example of the crystal structure of the OSC material having a faster oxygen storage-release rate than the OSC material having a pyrochlore-type structure is a fluorite-type structure. Since the OSC material having a fast oxygen storage-release rate has a faster oxygen storage-release rate than the OSC material having a pyrochlore-type structure, it can purify harmful components even when exhaust gas with a high flow rate is supplied in some embodiments.

Differing from the OSC material having a pyrochlore-type structure, the OSC material having a faster oxygen storage-release rate than the OSC material having a pyrochlore-type structure has a large specific surface area in some embodiments.

Specifically, the specific surface area of the OSC material having a fast oxygen storage-release rate, which is measured by a BET method, is, for example, 20 m²/g to 80 m²/g, and preferably 40 m²/g to 60 m²/g. In order to realize such a specific surface area, the specific shape of a preferred OSC material can be a powdery (particulate) shape. The mean particle diameter of such a powdery OSC material may be set at 5 nm to 20 nm, and preferably at 7 nm to 12 nm. When the particle diameter of the above-described OSC material is too small (or when the specific surface area is too large), the heat resistance of the OSC material itself is reduced and the heat resistance characteristics of the catalyst are reduced, and thus, it is not favorable. On the other hand, when the mean particle diameter of the above-described OSC material is too large (or when the specific surface area is too small), the oxygen storage-release rate becomes slow, and thus, it is not favorable.

The above two types of OSC materials, which are both present in the uppermost catalyst coating layer, are composed of the same composite oxide as each other, and the two types of OSC materials are different from each other only in terms of their crystal structure in some embodiments. In this case, the above two types of OSC materials are favorably dispersed in the uppermost catalyst coating layer. Thus, the oxygen storage-release rate of the OSC material having a fast oxygen storage-release rate can be further improved. Both the OSC material having a pyrochlore-type structure and the OSC material having a fast oxygen storage-release rate, which are allowed to coexist in the uppermost catalyst coating layer, are ceria-zirconia composite oxides in some embodiments.

In the present disclosure, by using the OSC material having a pyrochlore-type structure in combination with the OSC material having a faster oxygen storage-release rate than the OSC material having a pyrochlore-type structure, in specific contents, in the uppermost catalyst coating layer, exhaust gas purifying performance, OSC performance, and pressure loss can be optimized.

The content of the OSC material having a pyrochlore-type structure in the uppermost catalyst coating layer is 30 g/L to 50 g/L, and preferably 35 g/L to 45 g/L, based on the volume of the substrate. When the content of the OSC material having a pyrochlore-type structure in the uppermost catalyst coating layer is 30 g/L or more, high exhaust gas purifying performance (in particular, high NOx purifying performance) and sufficient OSC performance can be obtained. On the other hand, when the content of the OSC material having a pyrochlore-type structure in the uppermost catalyst coating layer is 50 g/L or less, high OSC performance and sufficient exhaust gas purifying performance (in particular, sufficient NOx purifying performance) can be obtained.

The content of the OSC material having a faster oxygen storage-release rate than the OSC material having a pyrochlore-type structure in the uppermost catalyst coating layer is 36 g/L to 72 g/L. and preferably 45 g/L to 60 g/L, based on the volume of the substrate.

When the content of the OSC material having a fast oxygen storage-release rate in the uppermost catalyst coating layer is 36 g/L or more, low pressure loss and sufficient OSC performance can be obtained. On the other hand, when the content of the OSC material having a fast oxygen storage-release rate in the uppermost catalyst coating layer is 72 g/L or less, sufficient pressure loss and high OSC performance can be obtained.

Therefore, by setting the content of the OSC material having a pyrochlore-type structure in the uppermost catalyst coating layer to be 30 g/L to 50 g/L based on the volume of the substrate, and also, by setting the content of the OSC material having a faster oxygen storage-release rate than the OSC material having a pyrochlore-type structure in the uppermost catalyst coating layer to be 36 g/L to 72 g/L based on the volume of the substrate, exhaust gas purifying performance, OSC performance, and pressure loss can be optimized. Besides, the exhaust gas purifying catalyst of the present disclosure exhibits high NOx purifying performance in a constant rich state.

The mechanism in which exhaust gas purifying performance, OSC performance, and pressure loss are optimized by setting the contents of the above two types of OSC materials in the uppermost catalyst coating layer within the above-described predetermined ranges is assumed to be as follows. First, the OSC material having a pyrochlore-type structure has a low bulk and a small influence on pressure loss. However, since the OSC material having a pyrochlore-type structure has a slow oxygen storage-release rate, the reaction to a fluctuation in the air-fuel ratio A/F of exhaust gas is slow, and contribution to the improvement of OSC is small. On the other hand, the OSC material having a faster oxygen storage-release rate than the OSC material having a pyrochlore-type structure has high durability, high activity, and a fast oxygen storage-release rate. However, this OSC material largely affects pressure loss attended with an increase in the additive amount. In view of the foregoing, by using these two types of OSC materials exhibiting different characteristics regarding OSC performance and pressure loss in combination with each other, high OSC performance can be exhibited over a long period of time, while alleviating a fluctuation in A/F. As a result, the contribution of the OSC material having a pyrochlore-type structure to the improvement of OSC performance can be actualized. That is, by using two types of OSC materials exhibiting different characteristics regarding OSC performance and pressure loss, the increased amount of the OSC material necessary for the improvement of OSC performance can be minimized, and while a reduction in exhaust gas purifying performance and deterioration of pressure loss, which are caused by an increase in the amount of the OSC material, can be suppressed, OSC performance can be improved.

In the uppermost catalyst coating layer, the weight ratio between the OSC material having a pyrochlore-type structure and the OSC material having a faster oxygen storage-release rate than the OSC material having a pyrochlore-type structure is, for example, 1:0.5 to 1:2.4, and preferably 1:0.5 to 1:1.8.

The content ratio of the two types of OSC materials in the uppermost catalyst coating layer can be examined by measuring the peak intensity according to an X-ray diffraction method. Specifically, when an X-ray diffraction method is applied to constitutional materials of the uppermost catalyst coating layer, characteristic peaks appear around 2θ/θ=14° and around 2θ/θ=29°. Among these peaks, the peak around 2θ/θ=14° is derived from the pyrochlore-type structure, whereas the peak around 2θ/θ=29° is derived from another crystal structure (e.g., a fluorite-type structure). Accordingly, the value I_{14/29} obtained by dividing this peak intensity around 2θ/θ=14° by the peak intensity around 2θ/θ=29° is adjusted, so as to obtain an exhaust gas purifying catalyst, in which the above two types of OSC materials are comprised at suitable contents or weight ratio in the uppermost catalyst coating layer thereof.

In the uppermost catalyst coating layer, the OSC material having a pyrochlore-type structure and the OSC material having a faster oxygen storage-release rate than the OSC material having a pyrochlore-type structure can also be used as carriers for a precious metal catalyst. In this case, the OSC material having a fast oxygen storage-release rate is used as a carrier in some embodiments, because the oxygen storage-release rate can be further improved. In a preferred embodiment of the uppermost catalyst coating layer, the precious metal catalyst containing at least Rh is supported on the OSC material having a faster oxygen storage-release rate than the OSC material having a pyrochlore-type structure, and more preferably, Rh is supported on the OSC material having a fast oxygen storage-release rate.

The uppermost catalyst coating layer may comprise carriers other than the above-described OSC materials. The carrier material other than the above-described OSC materials can be a porous metal oxide with excellent heat resistance. Examples of the carrier material that can be used herein include aluminum oxide (alumina: Al₂O₃), zirconium oxide (zirconia: ZrO₂), silicon oxide (silica: SiO₂), and composite oxides comprising these metal oxides as main components. From the viewpoint of heat resistance, alumina is preferable. It is to be noted that the above-described metal oxide such as alumina may also be used in the form of not carrying a catalytic metal.

The uppermost catalyst coating layer comprises a precious metal catalyst containing at least rhodium (Rh). As precious metal catalysts other than Rh, conventionally known catalytic precious metals used as exhaust gas purifying catalysts can be used. For example, any metal included in the platinum group, an alloy comprising, as a main body, any metal included in the platinum group, and the like can be used in some embodiments. Examples of the precious metal other than Rh included in the platinum group include platinum (Pt), palladium (Pd), ruthenium (Ru), iridium (Ir), and osmium (Os). The precious metal catalyst consists of Rh in some embodiments.

The uppermost catalyst coating layer may also comprise, as subcomponents, other materials (typically, inorganic oxide). Examples of a substance that can be added to the uppermost catalyst coating layer include rare earth elements such as lanthanum (La) and yttrium (Y), alkaline earth elements such as calcium, and other transition metal elements. The content of other materials is 20% by weight to 80% by weight, based on the total amount of the materials.

In a preferred embodiment, the uppermost catalyst coating layer comprises a precious metal catalyst containing at least Rh, an OSC material having a pyrochlore-type structure, an OSC material having a faster oxygen storage-release rate than the OSC material having a pyrochlore-type structure, and a metal oxide. In a more preferred embodiment, the uppermost catalyst coating layer comprises Rh, an OSC material having a pyrochlore-type structure (preferably, a ceria-zirconia composite oxide), an OSC material having a faster oxygen storage-release rate than the OSC material having a pyrochlore-type structure (preferably, a ceria-zirconia composite oxide), and alumina, wherein Rh is supported on the OSC material having a faster oxygen storage-release rate than the OSC material having a pyrochlore-type structure.

The catalyst coating layer other than the uppermost layer is at least one layer that is present in a layer lower than the uppermost catalyst coating layer. The catalyst coating layer other than the uppermost layer consists of preferably one, two or three layers, and more preferably one layer.

The catalyst coating layer other than the uppermost layer comprises a carrier and a precious metal catalyst containing at least one of palladium (Pd) or platinum (Pt) that is supported on the carrier in some embodiments.

The catalyst coating layer other than the uppermost layer comprises a precious metal catalyst containing at least one of Pd or Pt. As a precious metal catalyst other than Pd or Pt, a conventionally known catalytic precious metal used in exhaust gas purifying catalysts can be used. Examples of such a catalytic precious metal that can be preferably used herein include any metal included in the platinum group and an alloy comprising, as a main body, any metal included in the platinum group. Examples of the precious metal other than Pd or Pt included in the platinum group include rhodium (Rh), ruthenium (Ru), iridium (Ir), and osmium (Os). The precious metal catalyst consists of Pd, Pt, or Pd and Pt in some embodiments.

In the catalyst coating layer other than the uppermost layer, the precious metal catalyst is supported on a carrier in some embodiments. The carrier material can be a porous metal oxide with excellent heat resistance. Examples of the carrier material that can be used herein include aluminum oxide (alumina: Al₂O₃), zirconium oxide (zirconia: ZrO₂), silicon oxide (silica: SiO₂), and a composite oxide comprising these metal oxides as main components. From the viewpoint of heat resistance, alumina is preferable.

The catalyst coating layer other than the uppermost layer may comprise an OSC material. Examples of the OSC material that can be used herein include cerium oxide (ceria: CeO₂) and composite oxides comprising the ceria (e.g., ceria-zirconia composite oxide (CZ or ZC composite oxide)). The above-described OSC material having a pyrochlore-type structure or OSC material having a faster oxygen storage-release rate than the OSC material having a pyrochlore-type structure may also be used. The OSC material having a fast oxygen storage-release rate is preferable. The OSC material may also be used as a carrier that carries a catalytic metal.

The catalyst coating layer other than the uppermost layer may comprise other materials (typically, inorganic oxides) as subcomponents. Examples of a substance that can be added to the catalyst coating layer other than the uppermost layer include rare earth elements such as lanthanum (La) and yttrium (Y), alkaline earth elements such as calcium and barium, other transition metal elements, and compounds comprising these substances. Among these substances, from the viewpoint of the improvement of exhaust gas purifying performance, barium compounds such as barium carbonate, barium oxide, barium nitrate or barium sulfate are preferable, and barium sulfate, which is stable in a temperature range and in an atmosphere in which the catalyst is used, is more preferable. The content of other materials is 1% by weight to 20% by weight, based on the total amount of the materials.

In a preferred embodiment, the catalyst coating layer other than the uppermost layer comprises a carrier, a precious metal catalyst containing at least one of Pd or Pt supported on the carrier, an OSC material, and a barium compound. In a more preferred embodiment, the catalyst coating layer other than the uppermost layer comprises a carrier, at least one of Pd or Pt supported on the carrier, a ceria-zirconia composite oxide, and barium sulfate.

The exhaust gas purifying catalyst of the present disclosure can be produced by coating a catalyst onto a substrate according to a method known to a person skilled in the art. That is, slurry comprising a component for each catalyst coating layer is coated onto a substrate according to a known wash coating method, etc., and this operation is repeatedly carried out, so that a desired number of catalyst coating layers can be formed on the substrate. In this case, for example, a component such as a carrier other than a catalytic metal may be formed by a wash coating method, and a catalytic metal may be then supported on the obtained layer by a conventionally known impregnation method, etc. Alternatively, wash coating may be carried out by using carrier powders on which a catalytic metal has previously been supported according to an impregnation method, etc.

In a preferred embodiment, when the catalyst coating layer has a two-layer structure consisting of an upper layer and a lower layer, slurry for the lower layer comprising a precious metal catalyst supported on a carrier is coated onto a substrate according to a known wash coating method, etc. to form a lower catalyst coating layer, and thereafter, slurry for the upper layer comprising a precious metal catalyst supported on an OSC material having a fast oxygen storage-release rate, and an OSC material having a pyrochlore-type structure, is coated onto the lower layer to form an upper catalyst coating layer, so that the exhaust gas purifying catalyst of the present disclosure can be produced.

### EXAMPLES

Hereinafter, the present disclosure will be more specifically described in the following examples. However, these examples are not intended to limit the technical scope of the present disclosure.

### 1. OSC Material

A ceria-zirconia (CeO₂—ZrO₂) composite oxide was used as an OSC material.

### Preparation of Ceria-Zirconia Composite Oxide (Pyrochlore ZC) Having Pyrochlore-Type Structure

28% by weight (49.1 g) of cerium nitrate aqueous solution, which was relative to CeO₂, 18% by weight (54.7 g) of zirconium oxynitrate aqueous solution, which was relative to ZrO₂, and a commercially available surfactant were dissolved in 90 mL of ion exchange water. Thereafter, ammonia water containing 25% by weight of NH₃ was added to the above mixed solution in an amount of 1.2 times equivalent to anions, so as to generate a co-precipitate. The obtained co-precipitate was filtrated and washed. Subsequently, the obtained co-precipitate was dried at 110° C., and was then calcined at 500° C. for 5 hours in the air to obtain a solid solution of cerium and zirconium. Thereafter, the obtained solid solution was crushed, using a crusher, to result in a mean particle diameter of 1000 nm, so as to obtain powders of CeO₂—ZrO₂ solid solution having a molar ratio between CeO₂ and ZrO₂ (CeO₂/ZrO₂) that was 1.09. Subsequently, these CeO₂—ZrO₂ solid solution powders were filled into a polyethylene bag, followed by deaeration of the inside thereof. The opening of the bag was sealed by heating it. Thereafter, using an isostatic pressing device, the bag was molded by pressurizing with a pressure of 300 MPa for one minute, to obtain a solid raw material of the CeO₂—ZrO₂ solid solution powders. Subsequently, the obtained solid raw material was placed in a crucible made of graphite, and the crucible was then sealed with a graphite cap, followed by reduction in Ar gas at 1700° C. for 5 hours. After completion of the reduction, the sample was crushed with a crusher to obtain powders of CeO₂—ZrO₂ composite oxide (pyrochlore ZC) having a pyrochlore-type structure, the mean particle diameter of which was approximately 5 μm.

Ceria-Zirconia Composite Oxide (ACZ) Having Faster Oxygen Storage-Release Rate than OSC Material Having Pyrochlore-Type Structure

A CeO₂—ZrO₂ composite oxide having a fluorite-type structure (CeO₂:ZrO₂ (weight ratio)=1:2) was used as an OSC material having a faster oxygen storage-release rate than the OSC material having a pyrochlore-type structure.

### 2. Preparation of Catalyst Having Two Catalyst Coating Layers

### Comparative Example 1

The catalyst of Comparative Example 1 was prepared as follows:

Lower layer: Pd(0.58)/Al₂O₃(65)+ZC(70)+barium sulfate(5)(the numerical values in the parentheses each indicate the coated amount (g/l L of substrate) with respect to the volume of the substrate) (a)

Using alumina (Al₂O₃) and palladium nitrate, Pd/Al₂O₃ was prepared by supporting Pd on Al₂O₃ according to an impregnation method. Thereafter, Pd/Al₂O₃, ceria-zirconia composite oxide (ZC) (CeO₂:ZrO₂=1:2 at a weight ratio), barium sulfate, and an Al₂O₃-based binder were added to and suspended in distilled water, while stirring, to prepare Slurry 1. The prepared Slurry 1 was poured into a honeycomb substrate made of cordierite (60H/2-9R-08), and an unnecessary portion was blown away using a blower, so that the wall of the substrate was coated with a lower catalyst coating layer. The lower catalyst coating layer was adjusted to comprise 0.58 g/L Pd, 65 g/L Al₂O₃, 70 g/L ZC, and 5 g/L barium sulfate, based on the volume of the substrate. After completion of the coating, the substrate was dried using a dryer retained at 120° C. for 2 hours, and was then calcined in an electric furnace at 500° C. for 2 hours.

Upper Layer: Rh(0.2)/Al₂O₃(25) (b)

Using Al₂O₃ and rhodium nitrate, Rh/Al₂O₃ was prepared by supporting Rh on Al₂O₃ according to an impregnation method. Thereafter, Rh/Al₂O₃ and an Al₂O₃-based binder were added to and suspended in distilled water, while stirring, to prepare Slurry 2. The prepared Slurry 2 was poured into the substrate on which the lower catalyst coating layer had been formed in the above (a), and an unnecessary portion was blown away using a blower, so that an upper catalyst coating layer was coated on the lower catalyst coating layer formed on the wall of the substrate. The upper catalyst coating layer was adjusted to comprise 0.2 g/L Rh and 25 g/L Al₂O₃, based on the volume of the substrate. After completion of the coating, the substrate was dried using a dryer retained at 120° C. for 2 hours, and was then calcined in an electric furnace at 500° C. for 2 hours.

### Comparative Examples 2 and 3

In Comparative Examples 2 and 3, each catalyst was obtained in the same manner as that of Comparative Example 1, with the exception that pyrochlore ZC was added to Slurry 2 used to form an upper catalyst coating layer, in amounts of 30 g/L and 70 g-L, respectively, based on the volume of the substrate.

### Comparative Example 4

In Comparative Example 4, a lower catalyst coating layer was produced in the same manner as that of Comparative Example 1, and thereafter, an upper catalyst coating layer was produced as follows:

Using ACZ and rhodium nitrate, Rh/ACZ was prepared by supporting Rh on ACZ according to an impregnation method. Thereafter. Rh/ACZ, Al₂O₃, and an Al₂O₃-based binder were added to and suspended in distilled water, while stirring, to prepare Slurry 2. The prepared Slurry 2 was poured into the substrate, on which the lower catalyst coating layer had been formed, in the same manner as that of Comparative Example 1, and an unnecessary portion was blown away using a blower, so that an upper catalyst coating layer was coated on the lower catalyst coating layer formed on the wall of the substrate. The upper catalyst coating layer was adjusted to comprise 0.2 g/L Rh, 36/g/L ACZ, and 25 g/L Al₂O₃, based on the volume of the substrate. After completion of the coating, the substrate was dried using a dryer retained at 120° C. for 2 hours, and was then calcined in an electric furnace at 500° C. for 2 hours.

### Comparative Example 6

In Comparative Example 6, a catalyst was obtained in the same manner as that of Comparative Example 4, with the exception that ACZ was added to Slurry 2 used to form an upper catalyst coating layer, in an amount of 72 g/L based on the volume of the substrate.

### Examples 1 and 2 and Comparative Example 5

In Examples 1 and 2 and Comparative Example 5, each catalyst was obtained in the same manner as that of Comparative Example 4, with the exception that pyrochlore ZC was added to Slurry 2 used to form an upper catalyst coating layer, in amounts of 30 g/L, 50 g/L and 70 g/L, respectively, based on the volume of the substrate.

### Examples 3 and 4 and Comparative Example 7

In Examples 3 and 4 and Comparative Example 7, each catalyst was obtained in the same manner as that of Comparative Example 6, with the exception that pyrochlore ZC was added to Slurry 2 used to form an upper catalyst coating layer, in amounts of 30 g/L, 50 g/L and 70 g/L, respectively, based on the volume of the substrate.

### Comparative Example 8

In comparative Example 8, a catalyst was obtained in the same manner as that of Example 1, with the exception that ACZ was added to Slurry 2 used to form an upper catalyst coating layer, in an amount of 108 g/L based on the volume of the substrate.

With regard to the catalysts of Examples 1 to 4 and Comparative Examples 1 to 8, the contents of ACZ and pyrochlore ZC in the upper catalyst coating layer are shown in the following Table 1.

TABLE 1

| | ACZ(g/L) | Pyrochlore ZC (g/L) |
|---|---|---|
| Example 1 | 36 | 30 |
| Example 2 | 36 | 50 |
| Example 3 | 72 | 30 |
| Example 4 | 72 | 50 |
| Comparative Example 1 | 0 | 0 |
| Comparative Example 2 | 0 | 30 |
| Comparative Example 3 | 0 | 70 |
| Comparative Example 4 | 36 | 0 |
| Comparative Example 5 | 36 | 70 |
| Comparative Example 6 | 72 | 0 |
| Comparative Example 7 | 72 | 70 |
| Comparative Example 8 | 108 | 30 |

### 3. Evaluation

### (1) Durability Test

The catalysts of Examples 1 to 4 and Comparative Examples 1 to 8 were each equipped into the exhaust system of a V-type 8-cylinder 4.3-L petroleum engine, and they were then subjected to a durability test at a catalyst bed temperature of 1000° C., with a cycle comprising feedback, fuel cut, rich and lean per minute, for 50 hours.

### (2) OSC Performance Evaluation

After completion of the durability test, each catalyst was equipped into an L-type 4-cylinder 2.5-L petroleum engine, and the inlet gas temperature was set at 600° C. OSC was calculated based on the purifying behavior when the air-fuel ratio of the inlet gas atmosphere was switched between rich (A/F=14.1) and lean (A/F=15.1).

### (3) Steady Rich NOx Purification Percentage

After completion of the durability test, each catalyst was equipped into an L-type 4-cylinder 2.5-L petroleum engine, and the inlet gas temperature was set at 550° C. The NOx purification percentage was calculated, when the A/F rich (A/F=14.1) of the inlet gas atmosphere was continued.

### (4) Pressure Loss

Pressure loss was measured using a pressure loss measuring apparatus under conditions of a flow rate of 7 m³/sec.

### 4. Evaluation Results

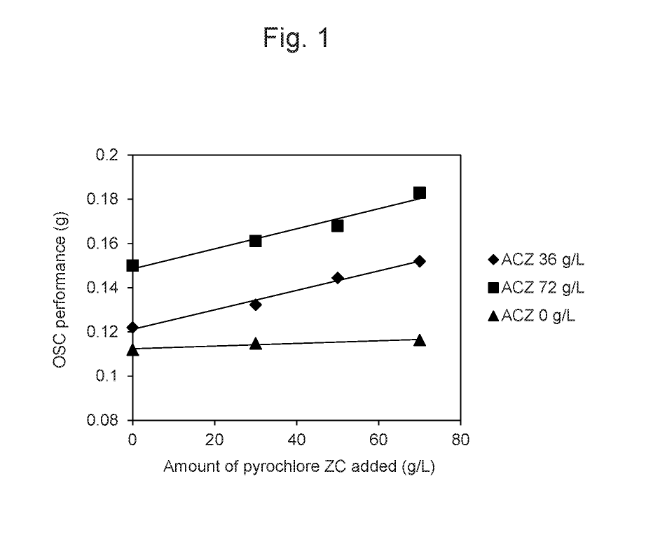

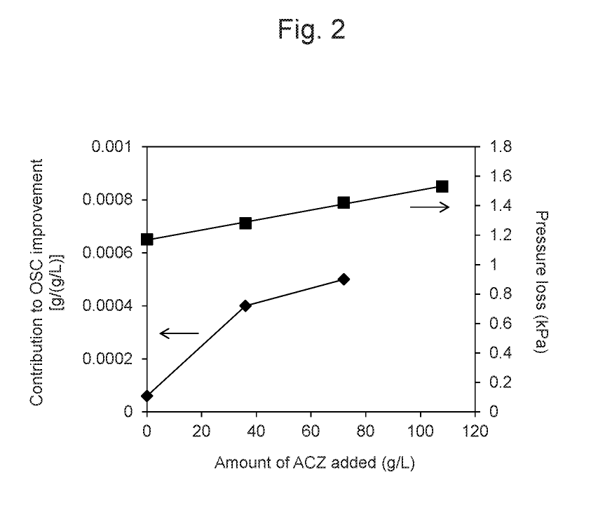

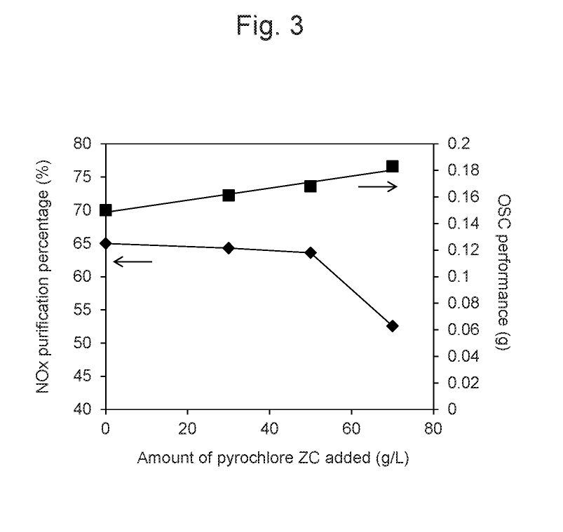

The results are shown in FIGS. 1 to 3. FIG. 1 is a graph showing the relationship between the amount of pyrochlore ZC added and OSC performance, upon addition of a predetermined amount of ACZ. FIG. 2 is a graph showing the relationship between the amount of ACZ added and the contribution of pyrochlore ZC to the improvement of OSC (in FIG. 2, shown as “Contribution to OSC improvement”) or pressure loss, upon addition of a predetermined amount of pyrochlore ZC (30 g/L). The term “the contribution of pyrochlore ZC to the improvement of OSC” means the improved amount of OSC performance with respect to an increase in the amount of pyrochlore ZC added, upon addition of a predetermined amount of ACZ (corresponding to the slope of each straight line in FIG. 1). In FIG. 2, square indicates pressure loss and diamond indicates the contribution of pyrochlore ZC to the improvement of OSC. FIG. 3 is a graph showing the relationship between the amount of pyrochlore ZC added and the NOx purification percentage or OSC performance, upon addition of a predetermined amount of ACZ (72 g/L). In FIG. 3, square indicates OSC performance and diamond indicates the NOx purification percentage.

As shown in FIG. 1, it is found that OSC performance tends to be increased, if the amount of pyrochlore ZC added is increased, while the amount of ACZ added is constant. In addition, by using pyrochlore ZC in combination with ACZ, the OSC performance was significantly increased (a comparison of the amount of ACZ added (0 g/L) with the amount of ACZ added (36 g/L or 72 g/L)). Moreover, when the improved amount of the OSC performance with respect to an increase in the amount of pyrochlore ZC added (corresponding to the slope of each straight line in FIG. 1) shown in FIG. 1 was determined to be the contribution of pyrochlore ZC to the improvement of OSC, the slope of such a straight line became large in the combined use of pyrochlore ZC and ACZ, and thus, the contribution of pyrochlore ZC to the improvement of OSC became significantly large. As described above, it was demonstrated that the contribution of pyrochlore ZC to the improvement of OSC is actualized by using ACZ in combination with pyrochlore ZC.

Furthermore, in FIG. 2, as the amount of ACZ added was increased, the contribution of pyrochlore ZC to the improvement of OSC became significantly large, as also shown in FIG. 1. Further, as shown in FIG. 2, pressure loss tended to be increased and deteriorated in proportion to the amount of ACZ added, when the amount of pyrochlore ZC added was constant. Accordingly, it is found that, in order to achieve both the high OSC performance and low pressure loss of a catalyst, the amount of ACZ added has a preferred range. Specifically, when the amount of ACZ added is less than 36 g/L, the contribution of pyrochlore ZC to the improvement of OSC is extremely small, although pressure loss is low. On the other hand, when the amount of ACZ added is more than 72 g/L, pressure loss exceeds an acceptable range, although the contribution of pyrochlore ZC to the improvement of OSC is large. In view of the foregoing, when the amount of ACZ added is 36 g/L to 72 g/L based on the volume of the substrate, the contribution of pyrochlore ZC to the improvement of OSC and pressure loss can be within a desired range, and thereby, both of them can be achieved.

Further, as shown in FIG. 3, when the amount of pyrochlore ZC added was increased while the amount of ACZ added was constant, the NOx purification percentage tended to be decreased, although OSC performance became high. Thus, it is found that, in order to achieve both the high OSC performance and a high NOx purification percentage of a catalyst, the amount of pyrochlore ZC added has a preferred range. Specifically, when the amount of pyrochlore ZC added is less than 30 g/L, OSC performance is low, although the NOx purification percentage is high. On the other hand, when the amount of pyrochlore ZC added is more than 50 g/L, the NOx purification percentage becomes extremely low, although OSC performance is high. In view of the foregoing, when the amount of pyrochlore ZC added is 30 g/L to 50 g/L, both OSC performance and the NOx purification percentage can be within a desired range, and thereby, both of them can be achieved.

As stated above, by using pyrochlore ZC as an OSC material having a pyrochlore-type structure, and ACZ as an OSC material having a faster oxygen storage-release rate than the OSC material having a pyrochlore-type structure, in predetermined contents, in an uppermost catalyst coating layer in an exhaust gas purifying catalyst, exhaust gas purifying performance (in particular, NOx purifying performance), OSC performance, and pressure loss could be optimized.

All publications, patents, and patent applications cited herein are incorporated herein by reference in their entirety.

What is claimed is:

1. An exhaust gas purifying catalyst having a substrate and two or more catalyst coating layers formed on the substrate, wherein the uppermost catalyst coating layer comprises
an OSC material having a pyrochlore-type structure,
an OSC material having a faster oxygen storage-release rate than that of the OSC material having a pyrochlore-type structure, and
a precious metal catalyst containing at least Rh, wherein
in the uppermost catalyst coating layer, the content of the OSC material having a pyrochlore-type structure is 30 g/L to 50 g L, based on the volume of the substrate, and the content of the OSC material having a faster oxygen storage-release rate than that of the OSC material having a pyrochlore-type structure is 36 g/L to 72 g L, based on the volume of the substrate.

2. The exhaust gas purifying catalyst according to claim 1, wherein the OSC material having a pyrochlore-type structure and the OSC material having a faster oxygen storage-release rate than that of the OSC material having a pyrochlore-type structure are both ceria-zirconia composite oxides.

3. The exhaust gas purifying catalyst according to claim 1, wherein the catalyst coating layer has a two-layer structure.

4. The exhaust gas purifying catalyst according to claim 1, wherein, in the uppermost catalyst coating layer, the precious metal catalyst containing at least Rh is supported on the OSC material having a faster oxygen storage-release rate than that of the OSC material having a pyrochlore-type structure.

5. The exhaust gas purifying catalyst according to claim 1, wherein at least one catalyst coating layer other than the uppermost layer comprises a carrier and a precious metal catalyst containing at least one of Pd or Pt that is supported on the carrier.
